(19) United States
(12) Patent Application Publication
(10) Pub. No.: US 2017/0217359 A1
(43) Pub. Date: Aug. 3, 2017

(54) Motor Vehicle with a Lightweight Dashboard and a Lightweight Steering Column

(71) Applicant: Bayerische Motoren Werke Aktiengesellschaft, Muenchen (DE)

(72) Inventors: Sebastian HUETTNER, Schwabhausen (DE); Christian LIEBHARDT, Essenbach (DE)

(21) Appl. No.: 15/486,618

(22) Filed: Apr. 13, 2017

Related U.S. Application Data
(63) Continuation of application No. PCT/EP2015/073544, filed on Oct. 12, 2015.

(30) Foreign Application Priority Data
Oct. 14, 2014 (DE) 10 2014 220 799.1

(51) Int. Cl. B60Q 1/14; B60Q 1/34; B60Q 1/30; B60R 1/00; B60Q 1/48

(52) U.S. Cl. CPC B60Q 1/143; B60R 1/00; B60Q 1/48; B60Q 1/30; B60Q 1/346; B60S 1/46

(57) ABSTRACT

A motor vehicle equipped with a parking light, a low-beam and a high-beam, and with a dashboard and a steering column. For the purpose of realizing a lightweight construction concept, the parking light, the low-beam and the high-beam are automatically controllable via information from a navigation system and from at least one camera for the environment around the vehicle, and the vehicle does not have any operating device operable by the driver for the parking light, the low-beam and/or the high-beam with at least one button, at least one switch and/or at least one operating lever in or on a dashboard or on a steering column.

### CROSS REFERENCE TO RELATED APPLICATIONS

This application is a continuation of PCT International Application No. PCT/EP2015/073544, filed Oct. 12, 2015, which claims priority under 35 U.S.C. §119 from German Patent Application No. 10 2014 220 799.1, filed Oct. 14, 2014, the entire disclosures of which are herein expressly incorporated by reference.

### BACKGROUND AND SUMMARY OF THE INVENTION

The present invention relates to a motor vehicle having parking lights, low-beam headlights and high-beam headlights and having a dashboard and a steering column. Further, the invention relates to a method for operator control of a motor vehicle.

The prior art discloses that an operator control unit for light functions is fitted into the dashboard. The operator control elements typically fitted therein can be used to switch running lights and parking lights on and off. Operator control of a headlight flasher and alternation between high-beam headlights and low-beam headlights are usually achieved by a lever on the steering column. A disadvantage of this is that the weight of these operator control elements, and additionally the operator control forces, need to be taken into consideration when designing the strength of the dashboard and support. Particularly the weight becomes detrimentally noticeable because not only static forces but also, in particular, dynamic forces resulting from vibrations need to be taken into consideration, said dynamic forces sometimes being able to reach a greater extent than the static forces.

It is therefore an object of the invention to achieve a design for the dashboard and for the steering column that is less susceptible to vibration and at the same time more lightweight.

The object is achieved by a motor vehicle according to embodiments of the invention. The operator control elements for the parking lights, the low-beam headlights and the high-beam headlights are omitted for the purposes of lightweight design, the functions thereof being provided in an alternative manner. For the parking lights, the low-beam headlights and the high-beam headlights, automatic operation can be achieved by using information from a navigation system and from at least one camera or camera system for the vehicle surroundings in order to switch said functions on and off. Hence, particularly information from the navigation system and from the camera for the vehicle surroundings is combined. Buttons, switches and/or control levers in or on a dashboard or on a steering column can therefore be eliminated.

In particular, it is proposed to omit, moreover, driver-operable operator control devices for a rear fog light, a fog light and/or daytime running lights. These functions can likewise be performed by means of information from a navigation system and/or from a camera for the vehicle surroundings, in particular automatically and without intervention by the driver. Hence, the lightweight design concept is implemented further. In particular, the information from the navigation system can be combined with information from the camera for the vehicle surroundings. Preferably, the automatic operation of the rear fog light, of the fog lights and/or of daytime running lights is additionally dependent on information that causes operation of the parking lights, of the low-beam headlights and of the high-beam headlights, and/or dependent on the state of operation thereof

Preferably, a headlight flasher and/or a wiper water delivery device is operable by an operator by virtue of the vehicle having a recognition device for voice and/or gestures that records and recognizes appropriate voice or gesture commands. To that end, a camera that depicts the driver may be provided for gesture recognition. A microphone and appropriate audio processing may be provided for recognizing voice. The cited measures mean that buttons, switches or levers for operator control of the headlight flasher and/or of the wiper water delivery device can be omitted, which are usually arranged in the dashboard or on the steering column in the prior art. This achieves improved implementation of the lightweight design concept.

Further, a motor vehicle is proposed that has a navigation system and/or a camera for the vehicle surroundings and also preferably a steering sensor. Further, this vehicle has a device that uses information from the navigation system, from the camera for the vehicle surroundings and from the steering sensor in order to activate and/or deactivate a direction of travel indicator. It is then possible to omit applicable operator control elements for the driver particularly on or in the dashboard and/or on the steering column. This measure also allows improved implementation of the lightweight design concept. In order to recognize when activation or deactivation of the direction of travel indicator is required, information from the navigation system, from the camera for the vehicle surroundings and from the steering sensor can be combined.

As a preference, a windshield wiper is controllable in the vehicle by use of information from a navigation system and from a rain sensor. The information from a navigation system can comprise particularly weather information or information about areas with particular weather conditions. This allows switches, pushbuttons and control levers on or in the dashboard and/or on the steering column for operator control of the windshield wiper to be omitted. In particular, with information from the rain sensor and information from a navigation system, it is possible to combine information that is associated with the switching on or off of light functions such as parking lights, low-beam headlights, high-beam head-lights, rear fog light, fog light and/or daytime running lights and also particularly with a wiper water delivery device. This achieves improved implementation of the lightweight design concept.

In a further aspect of the present invention, a method for operator control of a motor vehicle is proposed in which operator control of the parking lights, low-beam headlights, high-beam headlights, headlight flasher, direction of travel indicator and windshield wiper functions is performed in automated fashion. This is accomplished by using information from a navigation system, from a camera for the vehicle surroundings, from a voice and/or gesture controller, from a steering sensor and/or from a rain sensor, depending on the function to be operated. In this manner, it is possible to omit driver-operable operator control elements for the cited functions. As explained by way of introduction, this promotes the lightweight design concept in the dashboard and steering column regions.

In one embodiment of the method, a headlight flasher, a fog light, and/or a rear fog light are additionally controllable using the information cited with regard to the method.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 illustrates a dashboard of a motor vehicle according to the prior art.

FIG. 2 is a schematic diagram of the flow of information for automatic operation of various lighting functions of a motor vehicle.

FIG. 3 is a schematic diagram of the flow of information for automatic operation of a headlight flasher and of a wiper water delivery device of the motor vehicle.

FIG. 4 is a schematic diagram of the flow of information for automatic operation of a direction of travel indicator.

FIG. 5 is a schematic diagram of the flow of information for automatic operation of a windshield wiper.

### DETAILED DESCRIPTION OF THE DRAWINGS

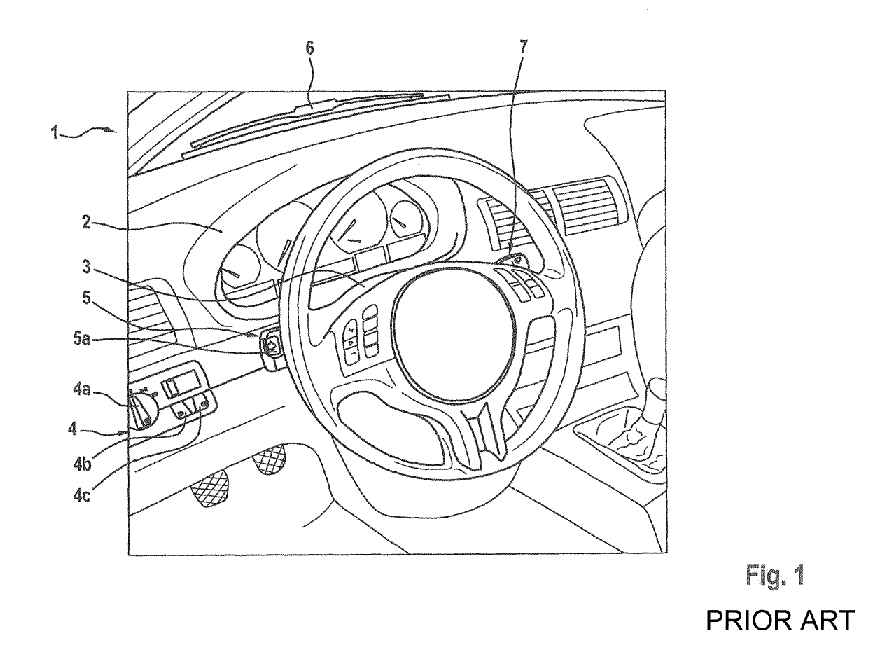

FIG. 1 shows a dashboard of a motor vehicle 1 according to the prior art. The motor vehicle 1 has a dashboard 2 in which an operator control unit 4 for various lighting functions is installed. In this case, a rotary switch 4a can be used to activate the parking lights and the running lights. Furthermore, two pushbuttons 4b and 4c can be used to activate separately a fog light and a rear fog light. Further, the motor vehicle 1 has a steering column 3 on which a multifunction control lever 5 is arranged. A direction of travel indicator can be activated and deactivated by moving this control lever 5 up and down in a known manner. Further, the headlight flasher can be activated and deactivated in a known manner by pulling/releasing the control lever 5. Arranged on the steering column 3, opposite the control lever 5, is a further control lever 7 that can be used by the driver to control a windshield wiper 6, e.g. by moving said further control lever up and down. Pulling/releasing the control lever 7 operates the wiper water delivery device in a known manner. The dashboard 2 and the steering column 3, as well as the supports thereof, have a rigidity that prevents excessive vibration of these elements. This necessitates considerable use of materials, leading to corresponding weight for said assemblies.

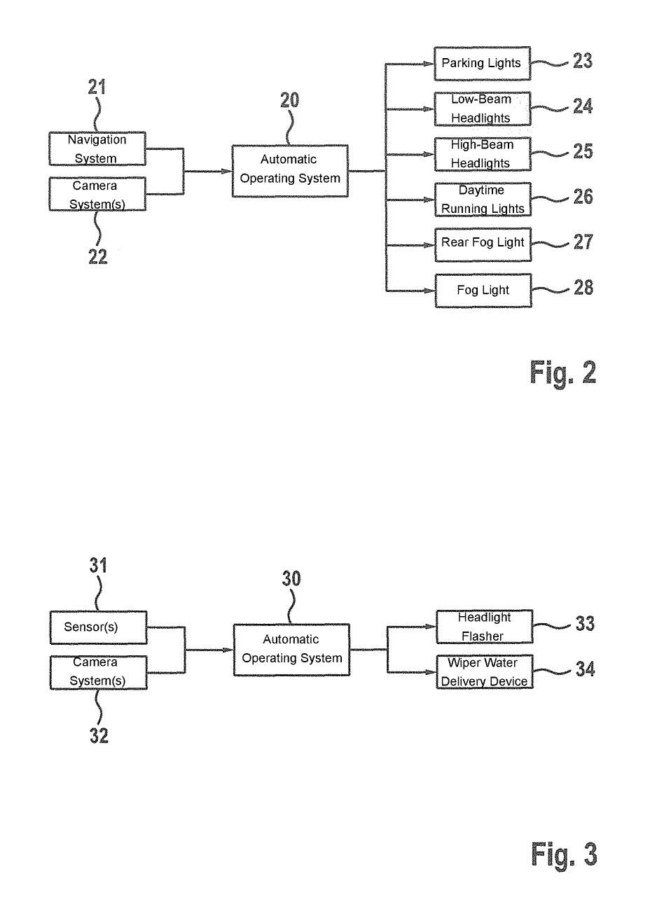

FIG. 2 schematically shows the flow of information for automatic operation of the parking lights 23, low-beam headlights 24, high-beam headlights 25, daytime running lights 26, rear fog light 27 and fog light 28. Operation is caused by an automatic operating system 20. The automatic operating system may be a processor-based system including memory and associated peripherals executing program code. The information for the automatic operating system 20 is supplied by a navigation system 21 and a camera or camera systems (for ambient data inter alia) 22 for the vehicle environment or surroundings. The automatic operating system 20 evaluates the information and automatically operates at least one of the lighting functions: parking lights 23, low-beam headlights 24, high-beam headlights 25, daytime running lights 26, rear fog light 27 and/or fog light 28. As an alternative to the structure shown for automatic operation of all of said types of lighting by way of a single automatic operating system, it is contemplated for a selection or just individual instances of these functions to be automatically operated and for this particularly also to involve more than one automatic operating system being used, the respective functions or groups thereof possibly having associated separate automatic operating systems.

FIG. 3 schematically shows the flow of information for automatic operation of a headlight flasher 33 and/or of a wiper water delivery device 34. Information from a sensor (e.g. acoustic) 31, for example from a microphone, and/or from a camera or camera systems (e.g. for gestures) 32 of the driver, is supplied to an automatic operating system 30 for operator control of the headlight flasher 33 and/or the wiper water delivery device 34. The automatic operating system 30 evaluates the information and automatically operates the headlight flasher 33 and/or the wiper water delivery device 34. The automatic operating system 30 comprises a voice and/or gesture controller. Alternatively, these functions may also be integrated in the camera systems (e.g. for gestures) 32 or in the sensor (e.g. acoustic) 31.

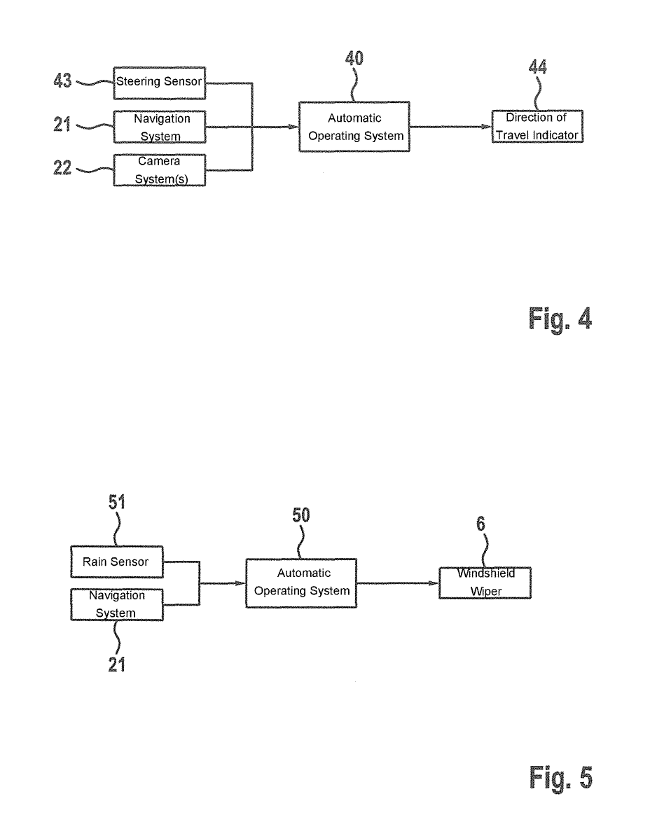

FIG. 4 schematically shows the flow of information for operation of a direction of travel indicator 44. An automatic operating system 40 for the direction of travel indicator 44 receives information from the navigation system 21 and the camera systems (for ambient data inter alia) 22. It is also possible for multiple cameras or camera systems for the vehicle surroundings to be used. Further, the automatic operating system 40 receives data from a steering sensor 43 that records movements of a steering wheel of the motor vehicle 1. The automatic operating system 40 ascertains when the direction of travel indicator 44 needs to be operated and automatically sends appropriate operating signals to the direction of travel indicator 44.

FIG. 5 schematically shows the flow of information for automatic operation of a windshield wiper 6 of the motor vehicle 1. An automatic operating system 50 for operating the windshield wiper 6 receives information from a rain sensor 51 and the navigation system 21. In particular, the navigation system 21 supplies weather data to the automatic operating system 50. The automatic operating system 50 evaluates the information from the rain sensor 51 and the navigation system 21, and automatically operates the windshield wiper 6 when required.

### LIST OF REFERENCE SYMBOLS

1 Motor vehicle

2 Dashboard

3 Steering column

4 Operator control device

4a Switch

4b Button for a fog light

4c Button for a rear fog light

5 Control lever for a direction of travel indicator

6 Windshield wiper

7 Control lever for the windshield wiper and wiper water delivery device

20 Automatic operator control system for the lighting

21 Navigation system

22 Camera or camera systems (for ambient data inter alia)

23 Parking lights

24 Low-beam headlights

25 High-beam headlights

26 Daytime running lights

27 Rear fog light

28 Fog light

30 Automatic operator control system for a headlight flasher and wiper water delivery device

31 Sensor (e.g. acoustic)

32 Camera or camera systems (e.g. for gestures)

33 Headlight flasher

34 Wiper water delivery device

40 Automatic operator control system for the direction of travel indicator

43 Steering sensor

44 Direction of travel indicator

50 Automatic operator control system for the windshield wiper

51 Rain sensor

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A motor vehicle, comprising:
parking lights;
low-beam headlights;
high-beam headlights;
a dashboard;
a steering column;
a navigation system that supplies information;
at least one camera that provides information of the motor vehicle surroundings, wherein
the parking lights, the low-beam headlights and the high-beam headlights are automatically controllable via information from the navigation system and from the at least one camera, and
the motor vehicle has no driver-operable operator control device for the parking lights, the low-beam headlights, and/or the high-beam headlights with a switch, a button, and/or a control lever in or on the dashboard or the steering column.

2. The motor vehicle according to claim 1, further comprising:
a rear fog-light;
a fog light; and/or
daytime running lights, wherein
the rear fog-light, the fog light and/or the daytime running lights are automatically controllable via information from the navigation system and from the at least one camera, and
the motor vehicle has no driver-operable operator control device for the rear fog-light, the fog light, and/or the daytime running lights with a switch, a button, and/or a control lever in or on the dashboard or the steering column.

3. The motor vehicle according to claim 2, further comprising:
a headlight flasher and/or a wiper water delivery device operable via one or more of voice and gesture control, wherein
the motor vehicle has no touch-based driver-operable operator control device for the headlight flasher and/or the wiper water delivery device with a switch, a button, and/or a control lever in or on the dashboard or steering column.

4. The motor vehicle according to claim 1, further comprising:
a headlight flasher and/or a wiper water delivery device operable via one or more of voice and gesture control, wherein
the motor vehicle has no touch-based driver-operable operator control device for the headlight flasher and/or the wiper water delivery device with a switch, a button, and/or a control lever in or on the dashboard or steering column.

5. The motor vehicle according to claim 1, further comprising:
a direction of travel indicator; and
a steering sensor, wherein
the direction of travel indicator is automatically controllable via information from the navigation system, from the at least one camera, and from the steering sensor, and
the motor vehicle has no driver-operable operator control device for the direction of travel indicator with a control lever, a button, and/or a switch in or on the dashboard or steering column.

6. The motor vehicle according to claim 1, further comprising:
a windshield wiper; and
a rain sensor, wherein
the windshield wiper is automatically controllable via information from the navigation system and from the rain sensor, and
the motor vehicle has no driver-operable operator control device for the windshield wiper with a switch, a button, and/or a control lever in or on the dashboard or the steering column.

7. A method for operator control of a motor vehicle equipped with parking lights, low-beam headlights, high-beam headlights, a navigation system, at least one camera for the motor vehicle surroundings, a direction of travel indicator, a headlight flasher, a windshield wiper, and a rain sensor, the method comprising the acts of:
automatically controlling the parking lights, the low-beam headlights, and the high-beam headlights via information from the navigation system and from the at least one camera;
automatically controlling the direction of travel indicator via said information and additionally information from the steering sensor;
controlling the headlight flasher and/or the wiper water delivery device via one or more of gesture and voice recognition; and
automatically controlling the windshield wiper via information from the navigation system and from the rain sensor.

8. The method according to claim 7, further comprising the act of:
automatically controlling a rear fog-light, a fog light and/or daylight running lights of the motor vehicle via information from the navigation system and from the at least one camera for the vehicle surroundings.
